(19) United States
(12) Patent Application Publication
(10) Pub. No.: US 2007/0167284 A1
(43) Pub. Date: Jul. 19, 2007

(54) Method for operating a drive train of a vehicle

(75) Inventors: Klaus Steinhauser, Kressbronn (DE); Peter Schiele, Kressbronn (DE); Maurizio Vecchio, Meckenbeuren (DE); Alf Zwingenberger, Tettnang (DE); Ruben Cuppers, Tettnang (DE); Stefan Schneider, Kempten (DE); Rainer Wassner, Bergatreute (DE); Wolfgang Kosling, Langenargen (DE); Reinhard Vollmar, Ravensburg (DE)

Correspondence Address: DAVIS & BUJOLD, P.L.L.C., 112 PLEASANT STREET, CONCORD, NH, 03301, US

(73) Assignee: ZF Friedrichshafen AG, Friedrichshafen (DE)

(21) Appl. No.: 11/653,535

(22) Filed: Jan. 16, 2007

(30) Foreign Application Priority Data
Jan. 17, 2006 (DE) 10 2006 002 122.3

(51) Int. Cl. F16H 61/26; F16H 59/00

(52) U.S. Cl. 477/156; 477/98

(57) ABSTRACT

A method for operating a drive train of a vehicle with a hydrodynamic torque converter, one transmission device and one prime mover during a gearshift starting from an actual ratio to a target ratio. A nominal standard of the control pressure of the shifting element to be disengaged is adjusted according to a nominal standard of the control pressure of the shifting element to be engaged. The rotational speed of a turbine of the torque converter is passed during the gearshift, starting from a synchronous rotational speed of the turbine of the actual ratio, in direction of a synchronous rotational speed of the turbine of the target ratio, the nominal standard of the control pressure of the shifting element to be disengaged.

This application claims priority from German Application Serial No. 10 2006 002 122.3 filed Jan. 17, 2006.

### FIELD OF THE INVENTION

The invention concerns a method for operating a drive train of a vehicle.

### BACKGROUND OF THE INVENTION

In the automatic transmissions and twin-clutch transmissions known from the practice, ratio changes needed in the transmission are converted as so-called overlapping gearshifts. Here a shifting element, such as a frictionally engaged multi-disc clutch in the power flow of a drive train of a vehicle, is switched out of the flow of power by way of a variable time, pressure profile or of a variable curve of a hydraulic control pressure of the shifting element to be engaged. At the same time, a shifting element to be engaged in the flow of power of the drive train for representing the target ratio sought by the needed gearshift is engaged in the flow of power by way of a variable curve dependent on the operative state of the control pressure of the shifting element to be engaged.

To make ensuring a high driving comfort possible, the transfer point at which the torque passed in the drive train between a prime mover and an output, is no longer passed via the shifting element to be disengaged, but via the shifting element to be engaged, is to be optimized in the sense that irregularities in the curve of the torque abutting on the output is prevented as much as possible.

Instabilities in the curve of the torque abutting on the output occur especially in the following operating states of a drive train designed with a hydrodynamic torque converter and an automatic transmission.

If the transmitting capacity of the shifting element to be disengaged, in a started shifting process of an upshift has, at an operation point of the drive train, a value at which the torque passed between the prime mover and the output of the vehicle can no longer be completely passed, via the shifting element, and if the transmitting capacity of the shifting element to be engaged still is at a level such that the torque still cannot be passed—even partially—by way thereof, the actual rotational speed of the turbine of the torque converter rises above the synchronous rotational speed of the actual ratio of the automatic transmission. This divergence is generally designated as flare.

As the transmitting capacity of the shifting element to be engaged increases, the actual rotational speed is passed in direction of the synchronous rotational speed of the turbine of the target ratio sought by the gearshift. The change of the rotational speed of the turbine when flare occurs results in an undesirably long interruption of the traction force and also shifting time, since the shifting element to be engaged essentially cannot be completely closed until reaching the synchronous rotational speed of the turbine of the target ratio without impairing the shifting comfort by jerks in undesired amounts.

During the started shifting process of a push upshift in an operating point of the drive train, if the transmitting capacity of the shifting element to be engaged has a value at which can already be passed, via the shifting element part of the torque, between the prime mover and the output of the vehicle, and if the transmitting capacity of the shifting element to be disengaged still is at a level such that the torque still can be passed at least partly via the shifting element to be disengaged, the actual rotational speed of the turbine of the torque converter lags below the synchronous rotational speed of the actual ratio of the automatic transmission, the same as a nominal curve of the rotational speed of the turbine in the transition area between the synchronous rotational speed of the turbine of the actual ratio and the synchronous rotational speed of the turbine of the target ratio. This divergence is generally designated as a tie-up.

With diminishing transmitting capacity of the shifting element to be disengaged, the actual rotational speed is passed in direction of the synchronous rotational speed of the turbine of the target ratio sought by the gearshift, the change of rotational speed of the turbine leading, upon occurrence of the tie-up, to an abrupt reduction of the input torque. This results from the fact that the shifting element to be engaged already transmits torque to a great extent although the shifting element to be disengaged still has transmitting capacity sufficient for this operation point. Likewise, this results in jerks that impair the shifting comfort, since the actual rotational speed of the turbine functions in direction of the target ratio only after pressure breakdown on the transmission limit of the shifting element to be disengaged and after torque build up on the shifting element to be engaged.

To adjust the optimal overlapping point or the optimal transfer point in conventionally designed automatic transmission, a regulating algorithm is usually provided in which a difference between an actual rotational speed of a turbine of a hydrodynamic torque converter of the drive train and the synchronous rotational speed of the turbine of the actual ratio represents a regulated quantity with reference to which the transfer moment required for a shifting excellence sought and a driving comfort dependent thereon is preset.

During an overlapping gearshift starting from a control pressure value at which the shifting element has its full transmitting capacity, the control pressure of the shifting element to be disengaged is first lowered, via a pressure ramp, to an output pressure and following that is reduced during several control phases taking into account several regulating parameters which are variable depending on different input quantities. The transmitting capacity of the shifting element to be disengaged is adjusted according to the torque actually abutting at the moment on the shifting element to be disengaged so that the difference between the actual rotational speed of the turbine and the synchronous rotational speed of the turbine of the actual ratio is minimal during the whole overlapping gearshift.

At the same time, during a quick filling phase and a pressure compensation phase that follows, the shifting element to be engaged is prepared for the engagement. The control pressure of the shifting element to be engaged is raised at the end of the pressure compensation phase in order that the shifting element to be engaged has the transmitting capacity required for engagement in the power flow of the automatic transmission. The raising of the transmitting capacity of the shifting element to be engaged causes the actual rotational speed of the turbine to be passed in the direction of the synchronous rotational speed of the turbine of the target ratio.

Continuously increasing requirements on the spontaneity of an automatic transmission and the shifting quality over the whole operating area of a drive train imply that both the regulating parameters and the transitions between the regulating phases of an overlapping gearshift are to be affected by a multiplicity of steps in order, on one hand, to be able to adequately adapt them to the requirements set and, on the other, to be able to take into account the given reaction times dependent on operating states of the system to be controlled. In addition, the requirements are also increased to a considerable extent by the regulated operation of the frictional pairings in the area of the shifting elements, chiefly temperature, rotational speed ranges and compression areas.

The procedure known from the practice thus represents an extremely complex system disadvantageously operable over the whole operating range of a drive train only at high control and regulation expenditure in order to achieve the shifting excellence sought and the driving comfort dependent thereon.

Therefore, this invention is based on the problem of making a method available for operating a drive train of a vehicle by way of which the desired shifting excellence and great driving comfort can be easily achieved.

### SUMMARY OF THE INVENTION

In the inventive method for operating a drive train of a vehicle having a hydrodynamic torque converter, a transmission device and a prime mover during a needed gearshift, preferably an upshift, starting from an existing actual ratio to a target ratio, a change from the actual ratio to the target ratio is introduced in the transmission device in the presence of a shifting signal by a reduction of the transmitting capacity of a shifting element engaged in the power flow of the automatic transmission to represent the actual ratio and by a simultaneous preparation of a shifting element to be engaged in the power flow of the transmission device to represent the target ratio sought.

According to the invention, a nominal standard of the control pressure of the shifting element to be disengaged is adjusted according to a nominal standard of the control pressure of the shifting element to be engaged, preferably variable depending on the operation state of the drive train so that during the gearshift, the actual rotational speed of a turbine of the torque converter, starting from a synchronous rotational speed of the turbine of the target ratio is passed in direction of a synchronous rotational speed of the turbine of the target ratio. In case of when the divergence of the actual rotational speed of the turbine from a predefined nominal standard of the rotational speed of the turbine, the nominal curve of the control pressure of the shifting element to be disengaged is varied until the divergence of the rotational speed of the turbine is less than the threshold value, especially also in the transition area between the synchronous rotational speed of the turbine of the actual ratio and the synchronous rotational speed of the turbine of the target ratio greater than a threshold value.

This means that the costly control system known from the practice is now replaced by a simplified control of the shifting elements of the transmission device that take part in the overlapping gearshift in which the shifting element to be disengaged is controlled according to the nominal standard of the control pressure of the shifting element to be engaged.

The inventive control advantageously offers, together with the simplified design of an overlapping gearshift, the possibility of compensating dispersions caused by tolerance and/or wear in the control behavior of the shifting element to be engaged by adequate adaptation routines known per se. Besides, with the proposed procedure it is also easily ensured that the curve of the nominal standard of the control pressure of the shifting element to be engaged for achieving the driving excellence sought and the accompanying driving comfort can be preserved by the control system “drive train”.

### BRIEF DESCRIPTION OF THE DRAWINGS

The invention will now be described, by way of example, with reference to the accompanying drawings in which:

FIG. 1 is an extensively schematized representation of a drive train of a vehicle;

FIG. 2 is several curves corresponding with each other of operation parameters of different parts of the drive train, according to FIG. 1, during a simple push upshift;

FIG. 3 is a curve of a nominal standard of the rotational speed of a turbine of a hydrodynamic torque converter and a curve diverging therefrom of the actual rotational value of the turbine, and curves corresponding therewith of the control pressure of the shifting element to be disengaged and of the shifting element to be engaged, and

FIG. 4 is a representation essentially corresponding to FIG. 3 of curves of the turbine rotational speed and of the control pressure of the shifting element to be disengaged during a push upshift upon an occurrence of flare.

### DETAILED DESCRIPTION OF THE INVENTION

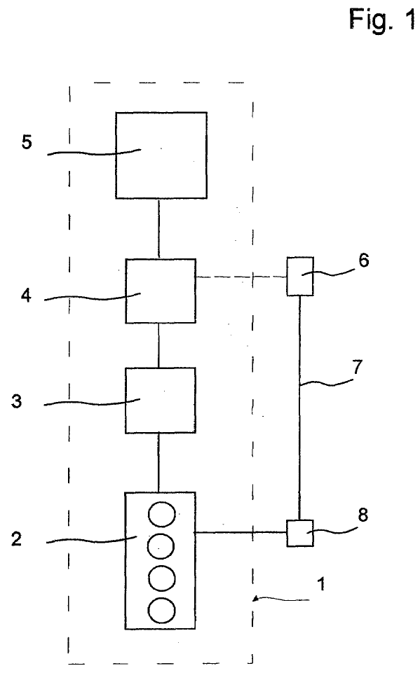

FIG. 1 shows an extensively schematized representation of a drive train 1 of a motor vehicle. The drive train 1 comprises, among others, one prime mover 2, one hydrodynamic torque converter 3, having a turbine as starting element, one transmission device 4, designed as an automatic transmission for representing different ratios and one output 5.

In the traction operation of the drive train 1, an input torque of the prime mover 2 is passed to the output 5 of the vehicle, via the hydrodynamic torque convert 3 and the automatic transmission 4 in the respectively adjusted ratio in the automatic transmission 4, corresponding to transformed height. In the coasting operation of the drive train 1, a torque in the drive train 1 is passed, starting from the output 5, via the automatic transmission 4, and the hydrodynamic torque converter 3 in the direction of the prime mover 2.

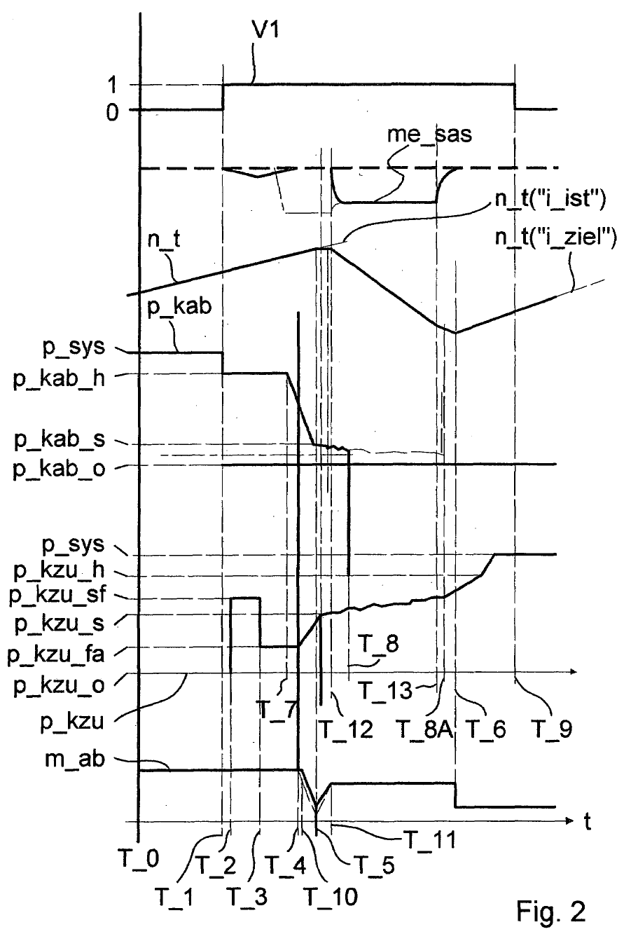

In a transmission control unit 6, with reference to the operation parameters shown in FIG. 2, using different shift characteristic fields stored in the transmission control unit 6 are determined, among others, ratios respectively adequate for the actual operation state taking into account a desired or selected driving strategy and, in turn, issued to the automatic transmission 4 being thus requested in the form of a shifting demand or of a shift signal.

In addition, the transmission control unit 6 is connected via a CAN-bus 7, with a motor control unit 8 so that a communication is provided between the prime mover 2 and the automatic transmission 4 for control and regulation dependent on operation state of the drive train 1.

In FIG. 2, several curves of operation state parameters of different parts of the drive train 1 are shown superimposed, which correspond with each other and adjust themselves during an upshift, starting from an actual transmission ratio i_ist to a target transmission ratio i_ziel.

A curve, designated with V1, indicates the status of the upshift, the value 0 of the curve V1 indicating that no shift signal abuts from the transmission control. If the curve V1 assumes the value 1, a shift signal abuts which releases the upshift carried out as overlapping gearshift.

Moreover. together with the curve V1 are the extensively schematized curve of a torque engagement me_sas of the transmission control on the prime mover 2, the curve of an actual rotational speed n_t_ist and a nominal standard of the rotational speed n_t of a turbine of the hydrodynamic torque converter 3 from FIG. 1, the same as curves of control pressures p_kab, p_kzu of the shifting elements to be controlled while the required gearshift is carried out in order to disengage them from the power flow or engage them therein.

At a moment T_0 at first still no shift signal from the transmission control unit 6 abuts on the transmission device or on the automatic transmission 4. The actual rotational speed n_t_ist corresponds to the moment T_0 both of the nominal standard of the rotational speed n_t of the turbine and of the synchronous rotational speed n_t(“i_ist”) of the turbine of the actual ratio i_ist.

The shifting element to be disengaged is controlled at the moment T_0 with system pressure p_svs and in this state is completely engaged. This means that the shifting element to be disengaged when the gearshift is later required, at this moment has its full transmitting capacity and a torque outcropping on the shifting element to be disengaged is completely and slip-free transmitted by it.

At the moment T_1, a shifting requirement on the control unit side abuts on the transmission 4 starting from the existing actual ratio i_ist in direction of a target ratio i_ziel, the control pressure p_kab of the shifting element to be disengaged being lowered by the system pressure p_sys to a holding pressure value p_kab_h. The shifting element to be disengaged, when the holding pressure value p_kab_h abuts, is the same as before completely engaged and operated slip-free. The holding pressure value p_kab of the shifting element to be disengaged produces such a change of the transmitting capacity of the shifting element to be disengaged that the shifting element to be disengaged passes to a slip operation.

The shifting element to be engaged is controlled at the moment T_0 with its opening pressure p_kzu_o at which the shifting element to be engaged transmits no torque.

After a moment T_2, temporarily following the moment T_1, the shifting element to be engaged is prepared, during a quick filling phase with a quick filling pressure p_kzu_sf and a pressure compensation phase that follows, with a filling compensation pressure p_kzu_fa for engagement in the power flow of the drive train 1 of the engagement. The quick filling phase being terminated at a moment T_3 and the filling compensation phase at a moment T_4.

Following the pressure compensation phase, the control pressure p_kzu of the shifting element to be engaged is raised up to a moment T_5 to a shifting pressure value p_kzu_s, via a pressure ramp function and, at the latter pressure value, the shifting element to be engaged is with a transmitting capacity such that the actual rotational speed n_t of the turbine is passed with increasing time t from a level of the synchronous rotational speed n_t(“i_ist”) of the turbine of the actual ratio i_ist in direction of the synchronous rotational speed n_t(“i_ziel”) of the turbine of the target ratio i_ziel in the manner shown in FIG. 2 by the curve of the nominal standard of the rotational speed n_t of the turbine.

The nominal standard of the rotational speed n_t of the turbine in FIG. 2 essentially divides in three ranges. In a first range, which essentially extends from the moment T_1 to the moment T_5, the actual rotational speed n_t_ist of the turbine corresponds to the synchronous rotational speed n_t(“i_ist”) of the actual ratio i_ist. A second range, which essentially extends between the moment T_5 and another moment T_6 of the predefined and variable curve of the nominal standard n_t of the rotational speed n_t(“i_ist”) of the turbine, represents a transition range between the synchronous rotational speed n_t(“i_ist”) of the turbine, represents a transition range between the synchronous rotational speed n_t(“i_ist”) of the turbine of the target ratio i_ist and the synchronous rotational speed n_t(“i_ziel”) of the turbine of the target ratio i_ziel. To this second range of the nominal standard n_t of the rotational speed of the turbine attaches the third range in which the actual rotational speed n_t_ist of the turbine corresponds to the synchronous rotational speed n_t(“i_ziel”) of the turbine of the target ratio i_ziel.

At a moment T_7, here stored before the moment T_4, the control pressure p_kab of the shifting element to be disengaged is lowered starting from the holding pressure value p_kab_h in direction of a shifting pressure value p_kab_s at which the shifting element to be disengaged is with transmitting capacity such that the actual rotational speed n_t_ist of the turbine—passed by the shifting element to be engaged—follows the nominal standard n_t of the rotational speed of the turbine in direction of the synchronous rotational speed n_t(“i_ziel”) of the turbine of the target ratio i_ziel.

At the end of the filling compensation phase, that is, from the moment T_4, the shifting element to be engaged is still controlled with the filling compensation pressure p_kzu_fa at which the transmitting capacity of the shifting element to be engaged is essentially zero; an increase originating therefrom of the control pressure p_kzu of the shifting element to be engaged produces an immediate rise of the transmitting capacity.

Both the control pressure p_kab of the shifting element to be disengaged and the control pressure p_kzu of the shifting element to be engaged during a regulated powershift phase, after reaching the respective shifting pressure values p_kab_s and p_kzu_s, are adjusted so that the actual rotational speed n_t_ist of the turbine between the moments T_5 and T_6 is passed, as shown in FIG. 2 in the most harmonic manner possible, and without instabilities in the curve of the rotational speed n_t of the turbine, from the synchronous rotational speed n_t(“i_ist”) of the actual ratio to the synchronous rotational speed n_t(“i_ziel”) of the turbine of the target ratio i_ziel.

At the earliest at a moment T_8 but at the latest at a moment T_8A, the control pressure p_kab of the shifting element to be disengaged is lowered to an opening pressure value p_kab_o at which the transmitting capacity of the shifting element to be disengaged is essentially zero, and the curve of the actual rotational speed n_t of the turbine is adjusted only via the transmitting capacity of the shifting element to be engaged is high enough to pass the actual rotational speed of the turbine. The selection of the disengagement moment in the period of time limited by the moments depends on the actual transmitting capacity of the shifting element to be engaged.

Shortly before the moment T_6, the control pressure p_kzu of the shifting element to be engaged, starting from an intermediate pressure value p_kzu_zw, is passed via ramp functions to a holding pressure p_kzu_h or to the system pressure value p_sys at which the shifting element to be engaged is fully closed having its full transmitting capacity.

At a moment T_9 at which the control pressure p_kab of the shifting element to be disengaged corresponds to the opening pressure value p_kab_o and at which the control pressure of the shifting element p_kzu to be engaged essentially corresponds to the system pressure p_sys, the needed gearshift is terminated.

In addition, a curve of an output torque m_ab is shown, corresponding with the idealized curve of the nominal standard of the rotational speed n_t of the turbine shown in FIG. 2, outcropping on the output and sought to adjust in the manner shown in FIG. 2, the highest possible driving comfort.

The output torque m_ab has here essentially between the moment T_0 and a moment T_10 stored before the moment T_5 an essentially constant curve. Shortly before the actual rotational speed n_t_ist of the turbine, starting from the synchronous rotational speed n_t(“i_ist”) of the turbine of the actual ratio i_ist is passed in direction of the synchronous rotational speed n_t(“i_ziel”) of the target ratio i_ziel, the output torque m_ab lowers as result of the decreasing transmitting capacity of the shifting element to be disengaged in the manner shown in FIG. 2 between the moments T_10 and T_5, the output torque m_ab having its minimum at the moment T_5 in the curve of the output torque m_ab, shown in idealized form in FIG. 2. Subsequently, the output torque m_ab again rises as result of the increasing transmitting capacity of the shifting element to be engaged and remains essentially constant at this value up to the moment T_6; the level of the output torque between moments T_11 and T-6 depending on the gearshift needed at the moment. This means that the level in sport gearshifts, for example, is higher and in economic driving behavior is adjusted to a lower level.

At the moment T_6 at which the actual rotational speed n_t_ist of the turbine corresponds to the synchronous rotational speed n_t(“i_ziel”) of the turbine of the target ratio i_ziel, the output torque m_ab lowers unsteadily to the torque value ab corresponding with the target ratio i_ziel.

The instability of the output torque m_ab appearing between the moments T_10 and T_11, while a needed upshift is being carried out, due to the deviations caused by production tolerances and/or wear in the control behavior of the shifting element to be engaged and/or the shifting element to be disengaged, is, under certain circumstances, intensifies to an extent such that the output torque lowers to an extent, reproduced in FIG. 2 by the dotted line, so that a driving comfort is impaired during the upshift to an undesired degree.

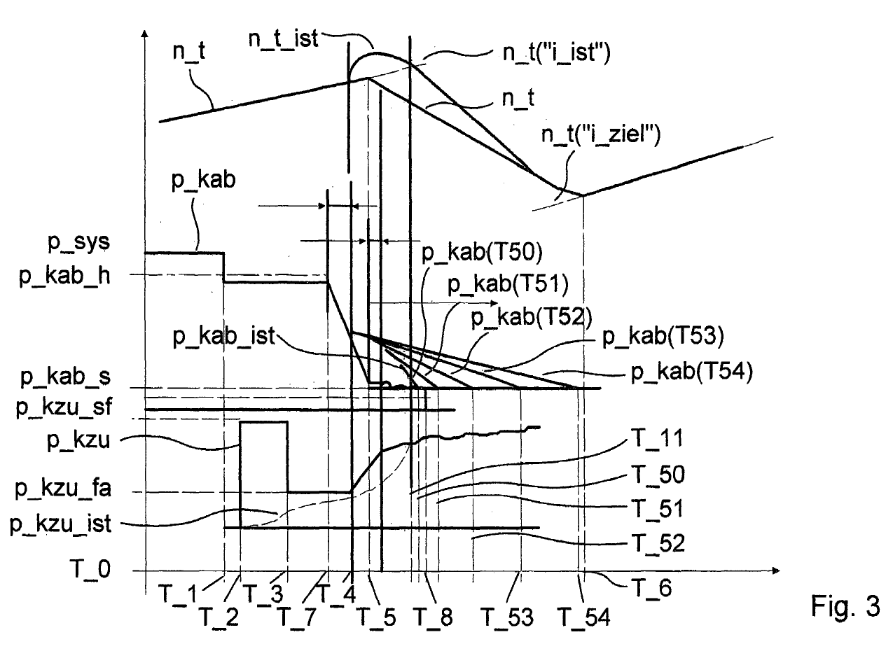

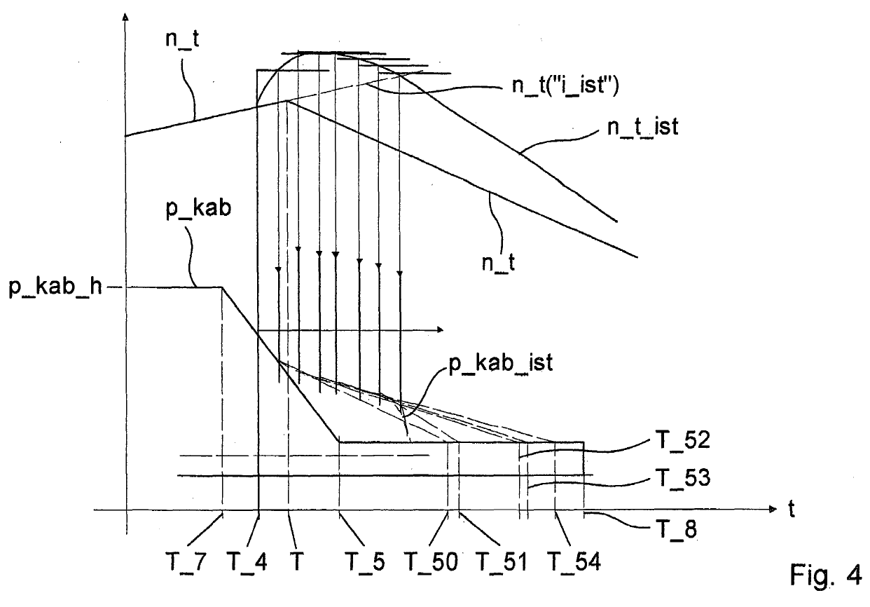

The dispersions in the control behavior especially become apparent in the area of the turbine by the so-called flare phenomena or the so-called tie-up phenomenon. The actual rotational speed n_t_ist of the turbine being higher when flare appears, then the synchronous rotational speed n_t(“i_ist”) of the turbine of the actual ratio i_ist and the curve of the actual rotational speed n_t_ist of the turbine having, an increase shown in FIG. 3 and FIG. 4, compared to the curve of the nominal standard n_t of the rotational speed of the turbine.

The rise of the actual rotational speed n_t_ist is produced by the fact that the output of a vehicle, both in the area of the shifting element to be disengaged and in the area of the shifting element to be engaged, is uncoupled from the part of the drive train on the turbine side in a manner such that the turbine is more strongly accelerated by the input torque of the prime mover than the part of the drive train on the output side. Both of the shifting element to be disengaged and the shifting element to be engaged are in slip operation in the operating state of the drive train. But the rise of the actual rotational speed n_t_ist of the turbine or flare is not designed since, on one hand, it results in instabilities in the curve of the output torque m_ab and, on the other, a shifting time is undesirably prolonged as result of the difference of rotational speeds between the actual rotational speed n_t_ist of the turbine and the synchronous rotational speed n_t(“i_ziel”) of the target ratio which has to be additionally overcome during the gearshift.

If the dispersions in the control behavior of the shifting element to be engaged and of the shifting element to be disengaged produce a tie-up, the actual rotational speed n_t_ist of the turbine lowers below the synchronous rotational speed n_t(“i_ist”) of the turbine of the actual ratio i_ist. This is produced by the fact that both the shifting element to be engaged and the shifting element to be disengaged have high transmitting capacities such that they obstruct them and in the drive train stresses appear which result in stalling of the driving power of the prime mover 2 in the form of idle power circulating in the transmission, whereby instabilities, likewise, undesirable are produced in the curve of the output torque m_ab.

The curve of the control pressure p_kab of the shifting element to be disengaged is basically adjusted according to the nominal standard p_kzu of the control pressure of the shifting element to be engaged in the manner described above in relation to FIG. 2. But if, during the needed gearshift, an undesirably great divergence appears in the form of flare, that is, above the threshold value of the actual rotational speed n_t_ist, from the synchronous rotational speed n_t(“i_ist”) of the actual rotational speed n_t_ist, the nominal standard of the control pressure p_kab of the shifting element to be disengaged, in the manner described herebelow in relation to FIG. 3 and FIG. 4, is varied independently of the nominal standard of the control pressure p_kzu of the shifting element to be engaged in the sense that the divergence between the actual rotational speed n_t_ist of the turbine from the synchronous rotational speed n_t(“i_ist”) of the turbine is reduced as harmonically as possible and without instabilities in the curve of the output torque m_ab to be produced.

Referring to FIG. 3 and FIG. 4, the provided control of the shifting element to be disengaged when flare occurs is described in detail herebelow. FIG. 4 shows an enlargement of FIG. 3 area of the curves of the rotational speed n_t of the turbine, of the actual rotational speed n_t_ist of the turbine, of the nominal standard of the control pressure p_kab of the shifting element to be disengaged, the same as a graphic representation of the inventive adaptation of the nominal standard of the control pressure p_kab of the shifting element to be disengaged that follows the holding phase when flare occurs.

In case of need of an upshift at the moment T_1, the nominal standard for the control pressure p_kab of the shifting element to be disengaged lowers from the system pressure p_sys to the holding pressure p_kab_h and, subsequently remains for a predefined period at this pressure value. Following this, the control pressure p_kab of the shifting element to be disengaged lowers in direction of the shifting pressure value p_kab_s. At the moment T_7, when the control pressure p_kab of the shifting element to be disengaged is lowered in direction of the shifting pressure value p_kab_s, a period of a so-called holding phase determined, according to the moment T_4 at which the nominal standard of the control pressure p_kzu of the shifting element to be engaged, is raised starting from the filling compensation pressure p_kzu_fa in direction of the shifting control pressure p_kzu_s.

In determining the duration of the holding phase, the duration of the filling compensation phase of the compensation element to be engaged is additionally taken into account, the duration of the filling compensation phase being adapted to the actual state of operation of the drive train by way of a time value. The time value is determined by way of a characteristic field stored in the transmission control unit according to the actual transmission input torque and an actual temperature of a hydraulic fluid of the hydraulic control system of the transmission 4, the time value being cyclically updated.

During the holding phase, which here terminates at the moment T_4, the nominal standard of the control pressure p_kab of the shifting element to be disengaged is additionally determined, taking into account correction parameters stored in a characteristic field of the transmission control unit according to the actual input torque and the actual temperature of the hydraulic fluid; there being no pressure limitation on the holding valve pressure value maximum at the moment.

After expiration of the holding phase, which extends between the moments T_7 and T_4, to a shifting pressure value p_kab_s is lowered with reference to another characteristic field which contains shifting pressure values which vary depending on the actual rotational speed n_t_ist and the turbine output torque.

The moment T_5 at which the control pressure p_kab of the shifting element to be disengaged reaches the shifting pressure value p_kab_s, according to the transmission input torque and the temperature of the hydraulic fluid, another characteristic field is varied by way of applied correction factors in a manner such that flare greater than a predefined, preferably applied and, in addition, also adaptable threshold value is neutralized in the manner shown in FIG. 3 until reaching the shifting pressure value p_kab_s. The cyclic change of the moment T_4 is graphically shown in FIG. 3 and FIG. 4 by the essentially linear curves that start from the moment T_4 of the control pressure p_kab (T_50), p_kab (T_51), p_kab (T_52), p_kab (T_53) and p_kab (T_54) with the respectively corresponding moments T_50, T_51, T_52, T_53 and T_54.

The actual curve p_kab_ist of the control pressure of the shifting element to be disengaged between the moments T_4, and T_11 is shown by the dotted curve in FIG. 3. Furthermore also shown in FIG. 3 as a dotted line, is an actual curve p_kzu_ist of the control pressure of the shifting element to be engaged together with the nominal standard p_kzu of the shifting element to be engaged.

From the representation of an actual curve p_kab_ist of the control pressure of the shifting element to be disengaged, the transmitting capacity of the shifting element to be disengaged can be inferred, due to the above described adaptation of the moment T_5 in direction of the moments T_50, T_51, T_52, T_53 and T_54 is higher than the one originally provided by the nominal standard of the control pressure p_kab of the shifting element to be disengaged. Thus the increase of the actual rotational speed n_t_ist of the turbine during a defined period is easily effectively opposed until the shifting element to be engaged has the transmitting capacity that is required for passing the actual rotational speed n_t_ist of the turbine. This is the case in the operation state curve at the moment T_11 at the bottom of FIG. 3.

If the moment T_5 at which the control pressure p_kab of the shifting element to be disengaged reaches the shifting pressure value p_kab_s before the moment T_4 at which the filling compensation phase is terminated and at which the control pressure p_kzu is raised in direction of the shifting pressure value p_kzu_s via a pressure ramp, the control pressure p_kab of the shifting element to be disengaged is irregularly lowered at the end of the holding phase to the shifting pressure value p_kab_s.

The above described procedure ensures that lowering of the transmitting capacity of the shifting element to be disengaged is delayed and via the shifting element to be disengaged such a torque can be passed so that the flare occurring is effectively countered and the difference between the actual rotational speed n_t_ist of the turbine and the curve of the nominal standard n_t of the turbine is reduced in the extent desired.

Although the variation of the moment at which the control pressure p_kab of the shifting element to be disengaged is passed in direction of the shifting pressure value p_kab_s is at the time carried out depending on the difference between the actual rotational speed n_t_ist of the turbine and the nominal standard of the rotational speed n_t of the turbine, the transmitting capacity of the shifting element to be disengaged is further reduced to such an extent like the transmitting capacity of the shifting element to be engaged increases by the nominal standard of the control pressure p_kzu of the shifting element to be engaged. At the same time, the turbine rotational speed n_t also, after falling below the synchronous rotational speed n_t(“i_ist”), is passed as desired in direction of the nominal curve n_t of the rotational speed of the turbine in the transition area between the synchronous rotational speed n_t(“i_ist”) and n_t(“i_ziel”) until the synchronous rotational speed n_t(“i_ziel”) of the target ratio is reached. In the operation point, the shifting element to be disengaged is completely disengaged from the power flow of the transmission while the shifting element to be engaged is completely engaged in the power flow of the transmission.

Together with determining the difference between the actual rotational speed n_t_ist of the turbine and the nominal standard n_t, it is possible to determine the manner, the same as the extent of the flare, also with reference to other criteria and the variation of the control pressure p_kab of the shifting element to be disengaged during the pressure ramp of the control pressure p_kzu of the shifting element to be engaged starting from the filling compensation pressure p_kzu_fa in direction of the shifting pressure value p_kzu_s takes place with reference to other detection criteria.

It is also possible for the purpose to determine, for example, the gradients of the curve of the actual rotational speed n_t_ist of the turbine and of the nominal curve n_t_soll of the rotational speed of the turbine in the transition area when flare occurs and to carry out the above described adaptation of the nominal standard of the control pressure p_kab of the shifting element to be disengaged.

When using the last mentioned procedure, it is also possible to determine the moment starting from which the control pressure of the shifting element to be disengaged is varied independently of the nominal standard of the control pressure of the shifting element to be engaged with reference to the gradients of the curve of the actual rotational speed n_t_ist of the turbine or with reference to the difference between the gradients of the curve of the actual rotational speed n_t_ist of the turbine and the nominal standard n_t of the rotational speed of the turbine in the transition area and taking into account other operation parameters adapt it to the actual operating state of the drive train. This means that when flare occurs, for example, a temperature and pressure relationship can be easily taken into account, the same as other relationships on the operation point of the transmission device.

In one other advantageous variation of the method, alternative to the above described adapted lowering of the control pressure of the shifting element to be disengaged after termination of the holding phase. It is provided that the nominal standard of the control pressure p_kab of the shifting element to be disengaged or the curve of the control pressure p_kab in the presence of flare greater than a threshold value for reducing flare independently of the nominal standard of the control pressure p_kzu of the shifting element to be engaged is at first kept constant above the pressure level at the end of the holding phase, that is, at the moment T_4. In such a procedure, another reduction of the control pressure p_kab of the shifting element to be disengaged during a retrogression of the flare is possible as well as an accompanying increase of the transmitting capacity of the shifting element to be disengaged, the reduction of the control pressure p_kab of the shifting element to be disengaged being again carried out preferably depending on the nominal standard for the control pressure p_kzu of the shifting element to be engaged. After termination of the constant pressure phase of the control pressure p_kab of the shifting element to be disengaged, the control pressure p_kab can be optionally lowered either with constant gradient, with varying gradient within an applicable residual time or irregularly to the shifting pressure p_kab_s.

It is also possible when flare occurs again to raise the control pressure p_kab at the end of the holding phase compared to the pressure level at the moment T_4 in order to counter to the desired extent the flare that occurs and reduce it in the way shown, this procedure being hard to dominate due to the dead time between control and effect upon the system.

Together with the above mentioned changes of the control pressure p_kab of the shifting element to be disengaged, there can be additionally provided when flare occurs, a motor engagement in which the input torque m_mot is lowered as needed, a so-called pre-motor engagement, a so-called main motor engagement and a so-called post-motor engagement is here differentiated. The pre-motor engagement extends here between the moment T_1 and a moment T_12. The main motor engagement directly follows the pre-motor engagement at the moment T_12 and is terminated at a moment T_13 while the post-motor engagement is started at the moment T_13 and closed at the moment T_9 at which the gearshift is finished.

When flare occurs, a forced engagement is superimposed on the pre-motor engagement whose intensity is determined by way of a characteristic field according to a difference between the actual rotational speed n_t_ist of the turbine and the synchronous rotational speed n_t(“i_ist”) of the actual transmission ratio i_ist of the turbine, the same as according to a turbine output torque. At the same time, the forced motor engagement is updated as needed for stronger engagements.

During the transition from the pre-motor engagement to the main motor engagement, a filtered changeover is made to the engagement intensity of the main motor engagement. Subsequently then carried out, as known per se, are the motor engagements provided in gearshifts without flare during the main motor engagement and the post-motor engagement.

It is obvious at the expert's discretion, as needed and depending on the operation state, to change in their effect subject to the operation state of the curve of the drive train the forced motor engagement and the other forced motor engagements that follow it with reference to other operation parameters in the same way as when controlling the pressure ramp of the control pressure p_kab of the shifting element to be disengaged and the moments T_5, T_50, T_51, T_52, T_53 or T_54.

When the control pressure p_kab of the shifting element to be disengaged reaches the shifting pressure value p_kab_s, a so-called shifting pressure phase is passed through during which, when the regulator of the function “regulated powershift” is active to the controlled pressure portion of the control pressure p_kab of the shifting element to be disengaged, a control portion is added. The shifting pressure phase of the shifting element to be disengaged is terminated by an applicable time allowance prior to reaching the synchronous rotational speed n_t(“i_ziel”) of the turbine of the target ratio i_ziel.

Alternative to this, it can also be provided that the shifting pressure phase of the shifting element to be disengaged is terminated when the shifting element to be engaged enters its regulated shifting pressure phase, this being the case at the moment T_8 in the embodiment shown in FIG. 3. If the shifting element to be disengaged is loaded with its minimal filling pressure or its opening pressure p_kab_o, the so-called regulating switch pressure is reached; there being then issued for the absolute pressure of the control pressure p_kab of the shifting element to be disengaged zero bar. This means that during the passage to the regulated powershift phase of the shifting element to be engaged, as last pressure value of the control pressure p_kab of the shifting element to be disengaged, a movement is made to zero bar or to a lower pressure value which does not result in any further torque transmission of the shifting element to be disengaged.

The regulated powershift phases of the shifting element to be engaged and of the shifting element to be disengaged are provided for the ratio of the nominal curve of the rotational speed n_t_soll of the turbine in the transition area between the synchronous rotational speed n_t(“i_ist”) of the actual transmission ratio i_ist and the synchronous rotational speed n_t(“i_ziel”) of the target ratio i_ziel; there being for the purpose switched back and forth as needed between regulation of the shifting element to be engaged and the shifting element to be disengaged, especially when changing from traction to coasting operation and vice versa.

It is here provided in a repeated shifting of the regulation from the shifting element to be engaged to the shifting element to be disengaged that a piston of the shifting element to be disengaged is again used by virtue of the pattern of a quick filling phase. The length of the quick filling phase is determined by way of a filling pattern stored behind in the transmission control unit. To prevent drifting of the regulation, the control pressure p_kab of the shifting element to be disengaged is limited to zero bar during the quick filling. During this phase, the control portion of the function “regulated powershift” is, in turn, given up; this phase being, likewise, terminated by a time condition prior to reaching the synchronous rotational speed n_t(“i_ziel”) of the turbine of the target ratio i_ziel.

With termination of the gearshift, that is, at the moment T_9, the shifting element to be disengaged is completely disengaged from the power flow of the drive train 1 and for the control pressure p_kab of the shifting element to be disengaged, there is issued electrically zero bar, which does not result in any torque transmission of the shifting element to be disengaged.

With the inventive method, a conventional and costly control system is easily possible to replace, which refers to a regulating algorithm by a simplified control which controls with reference to the nominal standard of the control pressure p_kzu of the shifting element to be engaged, the shifting element to be disengaged. Tolerances and changes determined by time of the clutches to be engaged can be easily compensated by way of adaptation routines known per se.

It is thus ensured that a nominal standard of the control pressure p_kzu of the shifting element to be engaged can be retained by the controlled system of the drive train. At the same time, both the values of the control pressure p_kab and p_kzu of the shifting element to be disengaged and of the shifting element to be engaged needed for the gearshift and also the timing of the transitions depend here respectively on the input parameters determinant of the operation points of the drive train, such as temperature, torque and rotational speed. Other control parameters which mainly emanate from the interpretation of the sport requirements of the driver can be more easily adjustable to these simplified determinant parameters for pressure and time behavior.

In addition, reaction possibilities to a clutch not to be engaged following the nominal curve and thus a delayed torque transmission capacity are, likewise, more easily convertible.

### REFERENCE NUMERALS

1 drive train
2 prime mover
3 hydrodynamic torque converter
4 transmission device
5 output
6 transmission control unit
7 CAN-bus
8 motor control unit
ab torque valve
i_ist actual ratio
i_ziel target ratio
m_ab output torque
me_sas torque engagement
m_mot input torque
n_t rotational speed of the turbine
n_t_ist actual rotational speed of the turbine
n_t“i_ist”) turbine synchronous rotational speed of the actual ratio
“i_ziel”) turbine synchronous rotational speed of the target ratio
n_t_soll turbine nominal curve of the rotational speed
p_kab control pressure of the shifting element to be disengaged
p_kab_ist actual curve of the control pressure of the shifting element to be disengaged
p_kzu control pressure of the shifting element to be engaged
p_kzu_ist actual curve of the control pressure of the shifting element to be engaged
p_kab_h holding pressure value of the shifting element to be disengaged
p_kzu_h holding pressure value of the shifting element to be engaged
p_kab_o opening pressure of the shifting element to be disengaged
p_kzu_o opening pressure of the shifting element to be engaged
p_kzu_sf quick filling pressure
p_kzu_fa filling compensation pressure
p_kab_s shifting pressure value of the shifting element to be disengaged
p_kzu_s shifting pressure value of the shifting element to be engaged
p_kzu_fa filling compensation pressure
p_kzu_sf quick filling pressure
p_kzu_zw intermediate pressure value
p_sys system pressure
t time
T_0 to T_13 discrete moment
V1 curve

1-20. (canceled)

21. A method for operating a drive train of a vehicle during a gearshift from an actual transmission ratio (i_ist) to a target transmission ratio (i_ziel), the drive train having a hydrodynamic torque converter (3), a transmission device (4) and a prime mover (2), the method comprising the steps of:
transmitting a shifting signal to the transmission device (4);
initiating a transmission ratio change by reducing a transmitting capacity of a shifting element engaged in a power flow of the automatic transmission (actual ratio (i_ist)) and simultaneously preparing a shifting element to be engaged in the power flow of the transmission device (target ratio (i_ziel));
adjusting a nominal standard of a control pressure (p_kab) of the shifting element to be disengaged, with respect to a nominal standard of the control pressure (p_kzu) of the shifting element to be engaged, such that an actual rotational speed (n_t_ist) of a turbine of the torque converter is altered, during the gearshift, from a synchronous rotational speed (n_t(“i_ist”)) of the turbine of the ratio (i_ist) to a synchronous rotational speed (n_t(“i_ziel”)) of the turbine of the target ratio (i_ziel); and
adjusting the nominal standard of the control pressure (p_kab) of the shifting element to be disengaged, until a divergence of the actual rotational speed (n_t_ist) from a predefined nominal standard (n_t) of the rotational speed of the turbine is less than a threshold value, when the divergence of the actual rotational speed (n_t_ist) from a predefined nominal standard (n_t) of the rotational speed of the turbine is higher than the threshold value.

22. The method according to claim 21, further comprising the step of compensating for dispersions, produced by at least one of tolerance and wear, in control behavior of the shifting element to be engaged by adaptation routines.

23. The method according to claim 21, further comprising the step of changing the control pressures (p_kab) of the shifting element to be disengaged, the control pressures (p_kzu) of the shifting element to be engaged and transition moments at which a curve of the actual rotational speed (n_t_ist) of the turbine depending on operation parameters that characterize operation points of the shifting element to be disengaged and operation points of the shifting element to be engaged.

24. The method according to claim 21, further comprising the step of lowering the control pressure (p_kab) of the shifting element to be disengaged, in the presence of a shifting need, from a pressure value (p_sys) at which the shifting element to be disengaged is completely closed to a holding pressure value (p_kab_h) at which the shifting element to be disengaged is still closed and while another pressure reduction of the control pressure (p_kab) of the shifting element to be disengaged passes to a slip operation.

25. The method according to claim 24, further comprising the step of pre-filling the shifting element to be engaged, in the presence of a shifting need during a quick filling phase and next a filling compensation phase, such that the shifting element to be engaged has a pressure value (p_kzu_fa) at which a transmitting capacity of the shifting element to be engaged is approximately zero and an increase of a control pressure (p_kzu) of the a shifting element to be engaged produces an increase of the transmitting capacity of the a shifting element to be engaged.

26. The method according to claim 21, further comprising the step of maintaining the control pressure (p_kab) of the shifting element to be disengaged during a variable time period at a pressure level of a holding pressure value (p_kab_h), the variable time period correcting itself, essentially up to an end of the filling compensation phase of the shifting element to be engaged, to extend a varying time value, depending on at least one of a transmission input torque and a temperature of hydraulic fluid of the transmission.

27. The method according to claim 26, further comprising the step of reducing the control pressure (p_kab) of the shifting element to be disengaged, after expiration of the variable time period, to a second control pressure (p_kab) determined by the actual rotational speed (n_t_ist) of the turbine and an actual output torque of the turbine.

28. The method according to claim 21, further comprising the step of reducing the control pressure (p_kab) of the shifting element to be disengaged via a pressure ramp, over a time period until reaching a shifting pressure value (p_kab_s), depending on transmission input torque and a temperature of hydraulic fluid of the transmission device, and depending on a moment at which the control pressure (p_kzu) of the shifting element to be engaged is raised by the filling compensation pressure (p_kzu_fa) in direction of the shifting pressure (p_kzu_s), at which the shifting element to be engaged is with a transmitting capacity such that the rotational speed (n_t) of the turbine is transferred from a level of a synchronous rotational speed (n_t(“i_ist”)) of the turbine of the actual ratio (i_ist) in direction of the synchronous rotational speed (n_t(“i_ziel”)) of the turbine of the target ratio (i_ziel).

29. The method according to claim 28, further comprising the step of jerkily lowering the control pressure (p_kab) of the shifting element to be disengaged, from a holding pressure (p_kab_h) to the shifting pressure (p_kab_s), when a moment at which the control pressure (p_kzu) of the shifting element to be engaged is raised to the shifting pressure value (p_kzu_s) is stored from the time point of view prior to the moment at which the control pressure (p_kab) of the shifting element to be disengaged reaches the shifting pressure value (p_kab_s).

30. The method according to claim 28, further comprising the step of changing the moment at which the control pressure (p_kab) of the shifting element to be disengaged reaches the shifting pressure value (p_kab_s) by a time value when the actual rotational speed (n_t_ist) of the turbine diverges more than the threshold value from the nominal standard (n_t) of the rotational speed of the turbine.

31. The method according to claim 30, further comprising the step of cyclically adapting the time value via the operational a curve of the drive train (1) during the gearshift according to the divergence of the actual rotational speed (n_t_ist) of the turbine from the nominal standard (n_t) of the rotational speed of the turbine.

32. The method according to claim 30, further comprising the step of determining the time period according to a gradient of a curve of the actual rotational speed (n_t_ist) of the turbine.

33. The method according to claim 30, further comprising the step of determining the time value according to a difference between a gradient of a curve of the actual rotational speed (n_t_ist) of the turbine and a gradient of a curve of the nominal standard (n_t) of the rotational speed of the turbine.

34. The method according to claim 30, further comprising the step of determining the time value according to different operating state parameters of the drive train (1).

35. The method according to claim 30, further comprising the step of keeping the control pressure of the shifting element to be disengaged, upon detection of a divergence of the actual rotational speed from the nominal standard of the rotational speed of the turbine greater than the threshold value, at the actual pressure value until the divergence is less than the threshold value, the control pressure being subsequently lowered within a time period determined on the shifting pressure value.

36. The method according to claim 30, further comprising the step of raising the control pressure of the shifting element to be disengaged, upon detection of a divergence of the actual rotational speed of the turbine from the nominal standard of the rotational speed of the turbine, greater than the threshold value, to a pressure value and kept at the pressure value until the divergence is less than the threshold value, the control pressure then being lowered within the time period determined to the shifting pressure value.

37. The method according to claim 31, further comprising the step of varying the input torque (m_mot) of the prime mover (2) to minimize the divergence of the actual rotational speed (n_t_ist) of the turbine from the nominal standard of the rotational speed of the turbine.

38. The method according to claim 31, further comprising the step of raising the control pressure (p_kzu) of the shifting element to be engaged, after reaching the shifting pressure value (p_kzu_s), during a regulated powershift phase to a pressure value at which the shifting element is in a slip-free state.

39. The method according to claim 38, further comprising the step of raising the control pressure (p_kzu) of the shifting element to be engaged, in slip-free state of the shifting element to be engaged, to the holding pressure (p_kzu_h) and then to the system pressure (p_sys).

40. The method according to claim 31, further comprising the step of lowering the control pressure (p_kab) of the shifting element to be disengaged, after reaching the shifting pressure (p_kab_s) during a regulated powershift phase, to a pressure value (p_kab_o) at which the shifting element is essentially open.
